(19) United States
(12) Patent Application Publication
(10) Pub. No.: US 2018/0100110 A1
(43) Pub. Date: Apr. 12, 2018

(54) METHOD AND APPRATUS TO PROCESS CELLULOSE FIBRES

(71) Applicant: ARC APPLIED SCIENCES LTD., London (GB)

(72) Inventor: Michael KOTYK, Gams (CH)

(73) Assignee: ARC APPLIED SCIENCES LTD., London (US)

(21) Appl. No.: 15/573,192

(22) PCT Filed: May 11, 2016
(86) PCT No.: PCT/EP2016/060560

§ 371 Date: Nov. 10, 2017

(30) Foreign Application Priority Data
May 13, 2015 (EP) 15167662.4

(51) Int. Cl. C10L 5/14; C10L 5/44; C08L 97/02; B27N 1/02

(52) U.S. Cl. CPC C10L 5/143; C10L 5/442; C10L 5/363; B27N 1/029; B27N 1/0209; C08L 97/02

(57) ABSTRACT

A method to process cellulose fibres, preferably including wood fibres, comprises the steps: Deriving first fibres having a first property from a first raw material comprising cellulose fibres, Milling the first fibres to provide milled fibres, preferably with an average characteristic fibre dimension greater than 100 μm, Drying the first fibres to provide dried fibres having a residual moisture less than 10% by weight, Adding one or more polymers, preferably including Lignin, to the dried fibres to provide a predetermined mixture including a polymer weight fraction of at least 5%, Processing the predetermined mixture to provide granules with an average characteristic granule dimension between 2 to 6 mm.

The present subject matter is concerned with a method to process cellulose fibres, with an apparatus to process cellulose fibres and with a product produced by the method or produced with the apparatus.

Goods comprising a thermoplastic and reinforcing fibres and methods to their manufacturing are known from the art. These goods can be summarised under simple consumables or can be designed to meet higher expectations concerning their quality. The effort associated with the manufacturing of such goods has been considered quite significant.

It is therefore an object of the present invention to provide a less complex way of manufacturing such goods.

### DESCRIPTION OF THE INVENTION

The above object is solved by a method to process cellulose fibres according to a first aspect of the invention and by an apparatus to process cellulose fibres according to a second aspect of the invention. Dependent claims are drawn to preferred embodiments of the method and the apparatus.

According to the first aspect, the method to process cellulose fibres, preferably including wood fibres, comprises the steps:
S1 Deriving first fibres having a first property from a first raw material comprising cellulose fibres,
S2 Milling the first fibres or dried first fibres to provide milled fibres (milling operation), preferably with an average characteristic fibre dimension greater than 100 μm, preferably after step S1,
S3 Drying the first fibres or the milled fibres to provide dried fibres having a residual moisture less than 10% by weight (drying operation), preferably after step S2, preferably after step S1,
S4 Adding one or more polymers, preferably including Lignin, to the dried fibres to provide a predetermined mixture including a polymer weight fraction of at least 5%, preferably after step S2 and step S3,
S5 Processing the predetermined mixture to provide granules with an average characteristic granule dimension between 2 to 6 mm.

By the above method a semi-finished product in the form of granules can be produced which can be handled conveniently during their storage, transport or later conversion into a finished product. The operator of a machine processing the granules need not handle further substances or chemicals whereby the manufacturing of the finished product is simplified and the underlying object is achieved.

The method may offer the advantage that an intended polymer weight fraction of the semi-finished product and/or finished product is achieved without the operator's particular attention.

The method may offer the advantage that the cellulose fibres moisture can be maintained at a specified percentage within the granules, which may contribute to the quality of the finished product, since the fibres are predominantly or entirely coated by the polymer. Particularly, this simplifies the storage of the semi-finished product or granules.

The method may offer the advantage that granules can be produced using a renewable raw material which helps to save other resources.

According to the second aspect, an apparatus for processing cellulose fibres, preferably including wood fibres, comprises:
a) deriving means arranged for deriving first fibres having a first property from a first raw material comprising cellulose fibres,
b) milling means arranged for receiving the first fibres from the deriving means and for milling the first fibres, alternatively arranged for receiving dried first fibres from the drying means and for milling the dried fibres, arranged for providing milled fibres with an average characteristic fibre dimension greater than 100 μm,
c) drying means arranged for receiving the milled fibres from the milling means and for drying the milled fibres, alternatively arranged for receiving the first fibres from the deriving means and for drying the first fibres, arranged for providing dried fibres having a residual moisture less than 10% by weight,
d) adding means arranged for receiving the dried fibres from the drying means, arranged for adding one or more polymers, preferably including lignin, to the dried fibres, for providing a predetermined mixture including a polymer weight fraction of at least 5%,
e) processing means arranged for receiving the predetermined mixture from the adding means, for processing the predetermined mixture, for providing granules with an average characteristic granule dimension between 2 to 6 mm.

With the above apparatus a semi-finished product in the form of granules can be produced which can be handled conveniently during their storage, transport or later conversion into a finished product. The operator of a machine processing the granules need not handle further substances or chemicals by which the manufacturing of the finished product is simplified and the underlying object is achieved.

The apparatus may offer the advantage that an intended polymer weight fraction of the semi-finished and/or finished product is achieved without the operator's particular attention.

The apparatus may offer the advantage that the cellulose fibres moisture can be maintained at a specified percentage, which may contribute to the quality of the finished product, since the fibres are predominantly or entirely coated by the polymer. Particularly, this simplifies the storage of the semi-finished product or granules.

The apparatus may offer the advantage that granules can be produced using a renewable raw material which helps to save other resources.

Within the sense of the invention, a fibre shall be understood as a continuous body the thickness or diameter of which is small compared with its length. This fibre may be separated from a piece of raw material comprising cellulose fibres. This raw material may be chosen from the following group including wood, paper, cotton, cloth, woven materials, hemp, sisal, miscanthus family members, miscanthus x giganteus. Some of the separated fibres may feature first properties (first fibres), particularly geometric or material properties, making them desirable as reinforcing fibres in the finished product. Some of the first fibres are treated during the steps of the method according to the first aspect and one or more of their properties may be modified during the steps or within the apparatus leading to modified first fibres, particularly to milled fibres, dried fibres, embedded fibres.

Within the sense of the invention, a polymer shall be understood as a chemical or substance comprising macromolecules composed of many repeated subunits. Both natural and synthetic macromolecules fall under the meaning of “polymer”. Within the semi-finished product one or more polymers may form a matrix embedding many of the modified first fibres and/or may form a coating of many of these fibres.

Within the sense of the invention, the characteristic fibre dimension shall be understood as an actual dimension of the fibre, preferably equal to its width, breadth, radius, diameter or cross sectional area. Alternatively, the characteristic fibre dimension refers to the radius or diameter of a circle which is as large as an actual cross sectional area of the fibre. An average, i.e. the average characteristic fibre dimension, may be calculated from the characteristic fibre dimension of a multitude of first fibres or milled fibres.

Within the sense of the invention, the predetermined mixture comprising dried fibres and one or more of the polymers is characterised by the polymer's weight fraction or by the total weight fraction of the contained polymers in the mixture. The polymer weight fraction ranges between 5% to 55% of the predetermined mixture, preferably between 10% to 25%.

Within the sense of the invention, the characteristic granule dimension is an actual dimension of the granule, preferably its width, breadth, diameter. Alternatively, the characteristic granule dimension refers to the diameter of a circle which is as large as an actual cross sectional area of the granule. An average, i.e. the average characteristic granule dimension, may be calculated from the characteristic granule dimension of a multitude of granules.

Within the sense of the invention, deriving shall be understood as an operation to select first fibres on the basis of a first property from the whole of the cellulose fibres and to separate the selected or desired first fibres from the rest of the cellulose fibres. At least some of the cellulose fibres which are rejected can serve as second fibres. The cellulose fibres vary in dimension but the dimension range of the desired first fibres is less wide than the dimension range of all of these cellulose fibres. The first fibres may be derived from the whole of the cellulose fibres on the basis of the first fibres' characteristic fibre dimension being in a preferred range. Additionally or alternatively, the first fibres may be derived from the whole of the cellulose fibres on the basis of the first fibres' colour being within a preferred range of colours. Additionally or alternatively, the first fibres may be derived from the whole of the cellulose fibres on the basis of their weight being in a preferred fibre weight range. Additionally or alternatively, the first fibres may be derived from the whole of the cellulose fibres on the basis of the first fibres' geometry being preferred to other geometries.

Within the sense of the invention, moisture shall be understood as the dimensionless fraction of liquid mass within a fibre divided by total fibre mass. Residual moisture shall be understood as the moisture of a fibre after a drying operation.

### Preferred Embodiments

Preferred embodiments are explained in the following and these embodiments may be combined advantageously unless stated otherwise.

In an embodiment, the temperature is kept below 120° C., preferably below 90° C., to protect the properties of the fibres, particularly to protect the fibres' lignin.

In an embodiment, the raw material comprises a lignin fraction of at least 12% by weight. This may offer the advantage that the lignin may contribute to the result of step S5 and/or may help to reduce the amount of polymers or of other additives added during step S4.

In an embodiment, the cellulose fibres originate from a single species of plants serving as raw material. Cellulose fibres originating from different species show different fractions of cellulose, hemicellulose and lignin. While cellulose and hemicellulose contribute to tensile strength, lignin rather improves compression strength (summarised under “mechanical properties”). Selecting the raw material from a particular species the particularly mechanical properties of the fibres and the granules can be adjusted. Preferably, the species is chosen because of the fibres' mechanical strength, elasticity, colour, average size of pores, ability to absorb moisture and/or density. Preferably, the species is chosen from the following group including hardwood, softwood, acacia, ash, beech, birch, elm, fir, larch, maple, oak, pine, poplar, robinia, spruce. This may offer the advantage that the granules can be adapted to better meet the demands of the finished product. This can also offer the advantage that the process parameters can be adjusted to suit the cellulose fibres of the single species.

In an embodiment, the raw material is chosen to comprise cellulose fibres from the heartwood, the vicinity of the heartwood and/or from the sapwood of a tree trunk. This may offer the advantage of providing first fibres having particular properties suitable for the granules and/or the finished product.

In an embodiment, step S1 includes passing some of the first fibres through a first dimension sensitive device. The first dimension sensitive device may have a sieve section, preferably with nominal openings to select fibres having a diameter less than 800 μm and/or having a length less than 5 mm. This may offer the advantage, that fibres separated from the first raw material and being too large can be rejected prior to step S2.

In an embodiment, step S1 includes retaining some of the first fibres by a second dimension sensitive device. Preferably, the second dimension sensitive device has a sieve section with nominal openings smaller than the nominal openings of the first dimension sensitive device to select fibres having a diameter greater than 100 μm and/or having a length greater than 1 mm. This may offer the advantage, that fibres separated from the first raw material which are too small can be rejected prior to step S2.

In an embodiment, step S1 includes the use of a series of dimension sensitive devices having decreasing nominal openings such that fibres of different predetermined characteristic fibre dimensions can be retained by these dimension sensitive devices providing first fibres particularly suitable for a finished product.

In an embodiment, deriving of first fibres is performed by at least one of following group of devices including a fibre dimension sensitive device, a fibre colour sensitive device, a fibre geometry sensitive device, a fibre density sensitive device, a fibre moisture sensitive device.

In an embodiment, deriving of first fibres is performed based on dimension, weight, geometry and/or colour of the cellulose fibres and fibres outside a preferred dimension range, weight range, colour range and/or group of geometries are rejected.

In an embodiment, the residual moisture of the first fibres prior to step S2 is between 10% and 8% by weight. Preferably, water is added to the first fibres if their residual moisture is less than 8% by weight. This may improve the result of step S2 and/or step S5.

In an embodiment, step S2 is performed to provide milled fibres with an average characteristic fibre dimension between 100 μm and 800 μm, preferably between 200 μm and 600 μm, or preferred between 300 μm and 500 μm. This may offer the advantage of a finer distribution of the fibres within the granules. This may also offer the advantage of improving the isotropy of the granules and/or the later finished product.

In an embodiment, step S2 is performed with a grinding device, preferably with a third dimension sensitive device. The first fibres are subjected to the grinding device and are converted into milled fibres being smaller than the first fibres. Preferably, the grinding device is made from an industrial ceramic, stone or hardened steel. Preferably, the grinding device has projections and/or recesses. Preferably, the third dimension sensitive device has a sieve section, preferably with nominal openings to select fibres having a diameter between 100 and 800 μm and/or having a length between 1 and 5 mm. Preferably, the third dimension sensitive device is arranged downstream of the grinding device. This may offer the advantage that the distribution of the characteristic fibre dimension is less wide.

In an embodiment, a drying operation of the first fibres precedes the milling operation, particularly when the first fibres moisture exceeds 15%, more particularly when the first fibres moisture exceeds 11%. This may lead to better milling and/or to more uniform milled fibres.

In an embodiment, step S3 or the drying operation is performed with a vacuum dryer or dispersion dryer. Drying may be terminated at a predetermined residual moisture of the fibres, preferably at a residual moisture of less than 10% by weight, more preferred of less than 2% by weight, more preferred less than 0.1%. This may offer the advantage that the later bonding of the polymer with the fibres is improved. This may offer the further advantage that evaporation of moisture during the manufacturing of the finished product is reduced.

In an embodiment, the fibres to be dried are exposed to an atmosphere having a predetermined temperature less than 120° C. and/or a relative humidity less than 5% during step S3. Preferably, the drying is a continuous process. Alternatively, the drying is performed in a closed chamber. This may offer the advantage that storing the milled fibres can be avoided.

In an embodiment, at least one of the polymers to be added to the dried fibres is a thermoplast or is chosen from the following group of polymers including lignin, polyethylene, polypropylene, polystyrene, polyamide, polycarbonate, acrylonitrile butadiene styrene, polymethyl methacrylate and polyoxymethylene. The polymer may be added in the form of a pellet or a resin. This may offer the advantage that the granules comprise the polymer which is desired or preferred for the finished product. This may offer the advantage that the finished product may be conveniently produced in a usual injection moulding machine.

In an embodiment, lignin is added to the dried fibres. Since lignin can be obtained from renewable raw material, other resources may be saved. Further, lignin is a natural partner of cellulose thereby offering a good material connection between the fibres and the lignin. Also, recycling of the finished product may be simplified.

In an embodiment, step S4 includes a mixing or stirring operation. This may dispose of agglomerations within the predetermined mixture.

In an embodiment, step S4 further includes adding second fibres from a second raw material to the predetermined mixture. Preferably, the mechanical properties of the second fibres differ from the mechanical or material properties of the first fibres. This may offer the advantage that the mechanical properties of the semi-finished product may be set to a desired value.

In an embodiment, step S5 is performed with an extruder or a multi screw extruder. The predetermined mixture is fed to the extruder or a multi screw extruder which produces the granules. This may offer the advantage that the distribution of the fibres within the granules is improved and/or agglomerations of fibres within the granules are reduced.

In an embodiment, step S5 is performed to provide granules with an average characteristic granule dimension between 3 to 5 mm. To achieve this, step S5 may include a breaking operation during which bigger granules are reduced in dimension. This may offer the advantage of reducing voids in a filling of granules to save space during storage, transport of the granules. This may also offer the advantage of saving space during the production of the finished product.

In an embodiment, the method further includes supplying the granules to a storage tank (step S6), preferably after step S5, from which storage tank some of the granules may be transferred to a mobile tank. Preferably, the storage tank also contains a substance to protect the granules from degradation, particularly preferred nitrogen and/or carbon dioxide. Preferably, the moisture within the storage tank may be controlled and/or set to predetermined moisture, particularly preferred less than 5%. This may offer the advantage that the granules may be produced continuously and/or shipped using the mobile tank according to the demand of a manufacturer of finished products.

In an embodiment, step S1 further includes deriving second fibres having a second property from the first raw material, and the method further comprises forming fuel pellets from the second fibres (step S7). Preferably, the second fibres lack the first property. This embodiment may offer the advantage that the waste percentage may be reduced.

In an embodiment, step S1 also includes deriving second fibres having a second property from the first raw material. Further, the method comprises processing the second fibres to gain thermal energy Q [J] (step S8), preferably by combustion. Also, the method includes providing the thermal energy Q during step S3 or S4 or S5 (step S9). This may offer the advantage that at least some the second fibres lacking desirable geometrical or material properties may be used to reduce the amount of energy being fed during steps S3 or S4 or S5.

In an embodiment, steps S1, S2 are performed such that the milling operation is continuously fed with first fibres, preferably at the same site. This may offer the advantage that the first fibres need not be stored.

In an embodiment, steps S4, S5 are performed such that the processing operation is continuously fed with the predetermined mixture, preferably at the same site. This may offer the advantage that the predetermined mixture need not be stored.

In an embodiment, at least one of the milling means, drying means and processing means is controlled to keep the fibres temperature below 120° C., preferably below 90° C. This may serve to maintaining the fibres' mechanical properties. This may serve to protect the fibre's lignin.

In an embodiment, the apparatus comprises a moisture detection device for detecting the moisture of one of the first fibres, the milled fibres, the dried fibres or the predetermined mixture. Preferably, the moisture detection device has one or more plate shaped bodies arranged for protruding into the fibres to sense their residual moisture. Preferably, the moisture detection device is arranged for the control of a wetting device of the apparatus, aiming to increase the residual moisture of the fibres for better results of any of the steps S2, S4 or S5.

In an embodiment, the apparatus comprises a wetting device arranged for increasing the residual moisture of the fibres, particularly for achieving better results of any of the steps S2, S4 or S5. Preferably, the wetting device is arranged upstream of the milling means or the mixing means.

In an embodiment, the deriving means comprise at least one of the devices of the following group including a dimension sensitive device, a geometry sensitive device, colour sensitive device, a sieve, an optical device, a CCD-camera, a wind winnowing device.

In an embodiment, the deriving means comprise a first dimension sensitive device arranged to reject fibres larger than a maximum dimension or the device's nominal openings. Thereby, coarser fibres among the cellulose fibres can be rejected. Preferably, these nominal openings are chosen not to retain fibres with a characteristic fibre dimension less than 800 μm. Alternatively, these nominal openings are chosen not to retain fibres with a characteristic fibre dimension less than 5 mm. Fibres which passed the first dimension sensitive device include the first fibres. This may offer the advantage of limiting the maximum fibre dimension within the later granules.

In an embodiment, the deriving means comprise a second dimension sensitive device to retain fibres larger than the means' nominal openings. Thus, fibres which are too small can be disposed of and the retained fibres may serve as first fibres. Preferably, these nominal openings are chosen to retain fibres with a characteristic fibre dimension greater than 100 μm. Alternatively, these nominal openings are chosen not to retain fibres with a characteristic fibre dimension greater than 1 mm. The second dimension sensitive device may be connected to the first dimension sensitive device to receive fibres which passed through the first dimension sensitive device. Preferably, the second dimension sensitive device has an outlet for the retained or first fibres. This outlet may be connected, preferably by a channel or pipe, to the milling means for feeding the retained or first fibres. This may offer the advantage of limiting the minimum fibre dimension within the later granules.

In an embodiment, the deriving means comprise an optical device, preferably a CCD-camera, arranged to recognize the fibres' colour and/or the fibres' geometry. Based on the fibres' colour and/or fibres' geometry the deriving means can reject fibres not being within a preferred colour range and/or a preferred geometry range. Thereby, first fibres of similar quality can be picked from the whole of the cellulose fibres. This may offer the advantage of providing first fibres with first properties being within a particular range as opposed to the rejected fibres.

In an embodiment, the deriving means are arranged for both conveying desired cellulose fibres i.e. the first fibres towards the milling means or towards the drying means and for rejecting those cellulose fibres which lack the first property (second fibres). The deriving means can have an oscillating tray with a pattern of openings which increase in size towards the end of the tray. The deriving means are arranged such that fibres can be drawn off from a section of the pattern the openings of which are within a preferred size range between 100 and 800 μm and can be conveyed to the milling means. At least some of the fibres not conveyed to the milling means can serve as second fibres. These deriving means may offer the advantage of being mechanically robust as well as scalable.

In an embodiment, the deriving means are arranged for both conveying desired cellulose fibres i.e. the first fibres towards the milling means or towards the drying means and for rejecting those cellulose fibres which lack the first property i.e. the second fibres. These deriving means make use of inertia and drag to distinguish between first fibres and fibres to be rejected. The cellulose fibres are given an initial velocity directed into a control volume, preferably by an airflow. In the control volume, the moving cellulose fibres which vary in weight and volume are decelerated due to air drag. The trajectory of a fibre also depends on its mass and cross sectional area. Thus, fibres having a desired size will arrive in a preferred section of the control volume from which they can be conveyed to the milling means. At least some of the fibres not conveyed to the milling means can serve as second fibres. These deriving means may offer the advantage of being mechanically robust as well as scalable.

In an embodiment, the apparatus comprises a metal separating device arranged for retaining or separating metal particles from the first fibres, preferably arranged before the milling means. Preferably, the metal separating device comprises a magnetic device, preferably a magnetic drum separator. The metal separating device may have a fibre guiding device such as a groove or race guiding the first fibres towards the milling means and preferably, the magnetic device is arranged in the vicinity of or above the fibre guiding device. This may serve to protect the apparatus, particularly the milling means. This may serve to reduce the formation of sparks.

In an embodiment, the milling means comprise a grinding device and preferably a third dimension sensitive device. The grinding device may be made from an industrial ceramic, stone or hardened steel and may have projections and/or recesses. The grinding device may be designed as a hammermill or a disc mill. The grinding device, particularly its third dimension sensitive device, may be arranged to provide milled fibres with an average characteristic fibre dimension between 100 μm and 800 μm, preferably between 200 μm and 600 μm, or preferred between 300 μm and 500 μm. This may offer the advantage of a finer distribution of the fibres within the granules. This may also offer the advantage of improving the isotropy of the granules and/or the later finished product.

The milled fibres may be released to the drying means by a channel or pipe. Alternatively, the grinding device can release the milled fibres to the third dimension sensitive device arranged to reject fibres the characteristic dimension of which exceeds a maximum dimension, preferably by a sieve section with nominal openings corresponding to the maximum dimension. Milled fibres being smaller than the maximum dimension can be guided to the drying means by a channel or pipe. Rejected fibres can be returned to the milling means for a second milling operation. This may offer an improved exploitation of the first fibres.

In an embodiment, the drying means comprise a vacuum dryer or dispersion dryer. The drying means may be arranged to terminate drying at a predetermined residual moisture of the fibres, preferably at a residual moisture less than 10% by weight, more preferred less than 3% by weight. This may improve the bonding of the polymer with the fibres. This may offer the further advantage that the evaporation of moisture during the manufacturing of the finished product is reduced.

In an embodiment, the drying means comprise a channel or pipe containing an atmosphere having a predetermined temperature less than 150° C. and/or a relative humidity less than 5%. Preferably, the temperature within the drying means is controlled such that the fibre's temperature remains below 120° C., preferably below 90° C. Additionally or alternatively the channel is equipped with heat sources radiating thermal energy, preferably infrared radiators or flames. The channel is arranged to receive the milled fibres and to release dried fibres. This may offer the advantage that the drying can be performed continuously by which storing of milled fibres can be avoided.

In an embodiment, the drying means comprise a chamber containing an atmosphere having a predetermined temperature less than 150° C. and/or a relative humidity less than 5%. Preferably, the temperature within the drying means is controlled such that the fibre's temperature remains below 120° C., preferably below 90° C. Additionally or alternatively the channel is equipped with heat sources radiating thermal energy, preferably infrared radiators or flames. The chamber is arranged to receive the milled fibres and to release dried fibres. The drying means can have at least two such chambers, one of which is open for being filled while the other chamber is closed for drying the milled fibres. Since the chamber temporarily fully encloses the fibres to be dried and gas volume, this may offer the advantage of better efficiency.

In an embodiment, the drying means comprise a belt dryer, particularly for continuous execution of step S3.

In an embodiment, the drying means are arranged upstream of the milling means, particularly when the first fibres moisture exceeds 15%, more particularly when the first fibres moisture exceeds 11%. This may lead to better milling and/or to more uniform milled fibres.

In an embodiment, the adding means comprise a container and a stirring device arranged inside the container. An inlet of the adding means or container may be connected with the drying means to receive dried fibres, preferably through a channel or pipe. An outlet of the adding means or container may be connected to the processing means to continuously feed the predetermined mixture. The stirring device is arranged to dispose of agglomerations of dried fibres and/or polymers with the predetermined mixture. The stirring device may be arranged to transport the predetermined mixture towards the outlet of the container and/or towards the processing means. This may offer the advantage that an operator need not handle the dried fibres nor the predetermined mixture.

In an embodiment, the adding means comprise a mixing device arranged for setting a first fraction of a first polymer and a second fraction, which may be different from the first fraction, of a second polymer to be combined in the predetermined mixture. Preferably, the mixing device is arranged upstream of the stirring device. This may offer the advantage that the material properties of the granules can be adapted to the finished product.

In an embodiment, the adding means comprise a mixing device arranged for setting a first fraction of first dried fibres and a second fraction, which may be different from the first fraction, of second dried fibres to be combined in the predetermined mixture. Preferably, the mixing device is arranged upstream of the stirring device. This may offer the advantage that the material properties of the granules can be adapted to the finished product.

In an embodiment, the processing means comprise an extruder or a multi screw extruder arranged for processing the predetermined mixture and for providing granules with an average characteristic granule dimension between 2 to 6 mm. In inlet of the processing means may be connected to the adding means, preferably by a channel or a pipe. The processing means may comprise a breaking device arranged for breaking granules the characteristic dimension of which exceeds an upper limit. The processing means may have separating device arranged for selecting granules the characteristic granule dimension of which falls below a lower limit and for separating the selected granules. This may offer the advantage of reducing voids in the filling of granules to save space during storage or transport of the granules. This may also offer the advantage of saving space during the production of the finished product.

In an embodiment, the apparatus comprises a fibre guiding device arranged for guiding the dried fibres from the drying means to the adding means. The fibre guiding device is arranged for containing a pressurised atmosphere for reducing or avoiding the influx of ambient air. Preferably, the fibre guiding device extends to the processing means. This may serve to avoid an increase of the residual moisture of the dried fibres.

In an embodiment, the deriving means are further arranged for deriving second fibres having a second property from the first raw material. Preferably, the derived second fibres lack the first property. The deriving means may have at least one of a dimension sensitive device, a colour sensitive device, a moisture sensitive device or a density sensitive device to retain the second fibres. The processing means may further comprise a pelletising device arranged for converting at least some of the second fibres to fuel pellets. This may offer the advantage of a smaller waste percentage.

In an embodiment, the apparatus comprises storage tank arranged for receiving some of the granules and arranged for releasing some of the granules to a mobile tank. Preferably, the storage tank also contains a substance to protect the granules from degradation, particularly preferred nitrogen and/or carbon dioxide. Preferably, the moisture within the storage tank is controlled and/or set to predetermined moisture, particularly preferred less than 5%. This may offer the advantage that the granules may be produced continuously and/or shipped using the mobile tank according to the demand of a manufacturer of finished products.

In an embodiment, the apparatus comprises a heat exchanger arranged for transferring thermal energy Q gained from the second fibres, preferably by combustion, to at least one of the drying means, the adding means and the processing means. This may offer the advantage that at least some of the second fibres lacking desirable geometrical or material properties may be used to reduce the amount of thermal energy being fed to at least one of the drying means, the adding means and the processing means.

A product or granule produced by a method according to the first aspect or according to one of its preferred embodiments may offer at least one of the following advantages:
convenient handling during storage, transport or later conversion into a finished product,
relieving the operator of a machine producing a finished product of the attention to separately feed the machine with fibres and polymers,
the granules may already comprise the predetermined ratio of fibres and polymers, which is decide for the finished product,
the fibres' moisture content is maintained at a specified percentage, since the fibres are predominantly or entirely coated by the polymer, which may contribute to the quality of the finished product,
the product makes use of a renewable raw material which helps to save the resources.

A product or granule produced with an apparatus according to the second aspect or according to one of its preferred embodiments may offer at least one of the following advantages:
convenient handling during storage, transport or later conversion into a finished product,
relieving the operator of a machine producing a finished product of the attention to separately feed the machine with fibres and polymers,
the granules may already comprise the predetermined ratio of fibres and polymers, which is decide for the finished product,
the fibres' moisture content is maintained at a specified percentage, since the fibres are predominantly or entirely coated by the polymer, which may contribute to the quality of the finished product,
the product makes use of a renewable raw material which helps to save the resources.

### BRIEF DESCRIPTION OF EMBODIMENTS

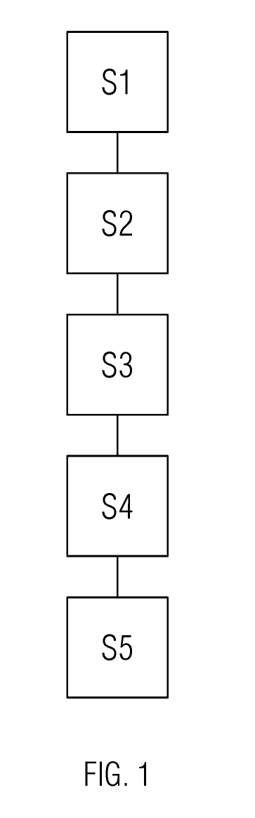

FIG. 1 shows a flowchart of the method according to the first aspect;

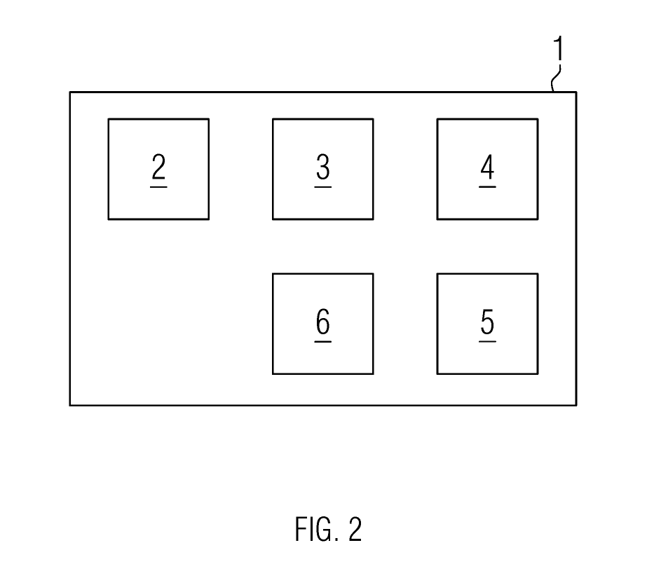

FIG. 2 shows an apparatus according to the second aspect.

FIG. 1 shows the method to process cellulose fibres, preferably including wood fibres, comprising the steps:
S1 Deriving first fibres having a first property from a first raw material comprising cellulose fibres,
S2 Milling the first fibres to provide milled fibres,
S3 Drying the first fibres to provide dried fibres having a residual moisture less than 10% by weight,
S4 Adding one or more polymers to the dried fibres to provide a predetermined mixture including a polymer weight fraction of at least 5%,
S5 Processing the predetermined mixture to provide granules with an average characteristic granule dimension between 2 to 6 mm.

Step S1 serves to select and to separate desired first fibres from the whole of the cellulose fibres stemming from the first raw material. The result of step S1 is that first fibres selected from the whole of the cellulose fibres will predominantly be subjected to the steps S2 to S5. The deriving can be based on the fibres' dimension, weight, colour and/or geometry and can be performed by a dimension sensitive device, a weight sensitive device, a colour sensitive device and/or a geometry sensitive device. The first fibres are released to be milled during step S2. Alternatively, the first fibres are released to be dried during step S3.

Step S2 serves to provide milled fibres with an average characteristic fibre dimension making use of most of the first fibres provided by step S1. A grinding device may be used to break bigger fibres into smaller ones, the smaller ones falling into a preferred dimensional range. Step S2 can be performed continuously and/or in combination with step S1. During step S2 the dimensional variation on the fibres is reduced. The milled fibres are released to be dried during step S3. Alternatively, the milled fibres are released to be combined with one or more polymers during step S4.

Step S3 serves to provide dried fibres making use of most of the milled fibres. The milled fibres can be exposed to the predetermined atmosphere and/or to radiating heat sources. The milled fibres can be dried continuously in a channel or intermittently using one or more chambers. Drying is terminated when an intended residual moisture of the fibres is achieved. The dried fibres are released to be combined with one or more polymers. Alternatively, the dried fibres are released to be milled during step S2.

Step S4 serves to provide a mixture comprising dried fibres and at least one polymer, the mixture having a defined polymer weight fraction. Preferably, agglomerations of the fibres or polymer(s) within the predetermined mixture are disintegrated. A mixing operation can be combined with conveying the predetermined mixture towards step S5.

Step S5 serves to provide granules having a predetermined characteristic dimension from the predetermined mixture. Subjecting the predetermined mixture to increased temperature and/or increased pressure, particularly by an extruder, leads to the formation of the granules. This step can be combined with step S4. These granules can be conveniently stored and can be converted to the finished product at a later point in time.

Preferably, the above method comprises at least one of the following:
the fibres temperature is kept below 120° C., preferably below 90° C.,
the cellulose fibres originate from a single species of plants,
a drying operation is performed prior to step S2, when the fibres moisture exceeds 15%, to improve the milling,
a first dimension sensitive device through which some of the first fibres are passed and a second dimension sensitive device by which some of the first fibres are retained are used during step S1,
at least one of the polymers to be added to the dried fibres is a thermoplast or is chosen from the following group of polymers including lignin, polyethylene, polypropylene, polystyrene, polyamide, polycarbonate, acrylonitrile butadiene styrene, polymethyl methacrylate and polyoxymethylene,
the dried fibres are guided through a fibre guiding device arranged for containing a pressurised atmosphere for reducing or avoiding the influx of ambient air,
second fibres are derived by step S1 and are formed to fuel pellets,
second fibres are derived by step S1, are processed to gain thermal energy Q and the thermal energy Q is provided during step S3, S4 or S5.

FIG. 2 shows an apparatus 1 according to the second aspect. The apparatus comprises
deriving means 2 arranged for deriving first fibres having a first property from a first raw material comprising cellulose fibres,
milling means 3 arranged for receiving the first fibres from the deriving means 2, for milling the first fibres, for providing milled fibres with an average characteristic fibre dimension greater than 100 μm,
drying means 4 arranged for receiving the milled fibres from the milling means 3, for drying the milled fibres, for providing dried fibres having a residual moisture less than 10% by weight,
adding means 5 arranged for receiving the dried fibres from the drying means 4, for adding one or more polymers, preferably including Lignin, to the dried fibres, for providing a predetermined mixture including a polymer weight fraction of at least 5%, and
processing means 6 arranged for receiving the predetermined mixture from the adding means 5, for processing the predetermined mixture, for providing granules with an average characteristic granule dimension between 2 to 6 mm.

The deriving means serve to select and to separate desired first fibres from the whole of the cellulose fibres stemming from the first raw material. The deriving means can comprise one or more dimension sensitive devices, a geometry sensitive device, colour sensitive device, receive, an optical device and/or the CCD-camera. The deriving means can release the first fibres, particularly continuously, to the milling means through a pipe or channel. Alternatively, the deriving means can release the first fibres to the drying means.

The milling means serve to provide milled fibres with an average characteristic fibre dimension making use of most of the first fibres provided by the deriving means. The milling means can also reduce the dimensional variation among the fibres. A grinding device may be used to break bigger fibres into smaller ones, the smaller ones falling into a preferred dimensional range. The milling means can operate continuously and in combination with the deriving means. The milling means can release the milled fibres to the drying means through a pipe or channel. Alternatively, the milling means can release the milled fibres to the adding means.

The drying means serve to provide dried fibres making use of most of the milled fibres. The drying means can comprise the predetermined atmosphere and/or radiating heat sources. The drying means can dry the milled fibres continuously in a channel. Alternatively, the milled fibres can be dried intermittently in one or more chambers. Preferably, one of these chambers is temporarily open for being filled with milled fibres and a second chamber is closed while drying. The drying means arranged to terminate drying when an intended residual moisture of the fibres is achieved. The drying means can release the dried fibres to the adding means through a pipe or channel. Alternatively, the drying means can release the dried fibres to the milling means.

The adding means serve to provide a mixture comprising dried fibres and at least one polymer, the mixture having a defined polymer weight fraction. Preferably, the adding means are arranged for disintegrating agglomerations of the fibres or the polymer(s) within the predetermined mixture. The adding means can have a mixing device which is preferably arranged for conveying the predetermined mixture towards the processing means. The adding means can release the predetermined mixture to the processing means through a pipe or channel.

The processing means serve to provide granules having a predetermined characteristic dimension making use of the predetermined mixture. The processing means are arranged for subjecting the predetermined mixture to an increased temperature and/or increased pressure leading to the formation of the granules. These granules can be conveniently stored and can be converted to finished products at a later point in time.

Preferably, the apparatus comprises at least one of the following:
a means of the apparatus which is controlled to keep the fibres temperature below 120° C., preferably below 90° C., and/or
drying means which are arranged upstream of the milling means arranged for reducing the fibres moisture to a value below 15%, and/or
deriving means comprising a first dimension sensitive device for which some of the first fibres may be passed and a second dimension sensitive device by which some of the first fibres can be retained, wherein the second dimension sensitive device is arranged downstream of the first dimension sensitive device, and/or
the fibre guiding device arranged for containing a pressurised atmosphere for reducing or avoiding the influx of ambient air and arranged between the drying means and the mixing means, and/or
the pelletising device arranged for forming fuel pellets from second fibres derived by the deriving means, particularly rejected by the first dimension sensitive device, and/or
the heat exchanger arranged for transferring thermal energy Q gained from the second fibres to at least one of the drying means, the adding means and the processing means, and/or
the wetting device arranged between the deriving means and the milling means, and/or
the moisture detection device arranged upstream of the milling means.

### LIST OF REFERENCE NUMERALS

1 apparatus
2 deriving means
3 milling means
4 drying means
5 adding means
6 processing means
7 heat exchanger
8 storage tank
9, 9a, 9b dimension sensitive device
10 pelletising device
11 grinding device
21 cellulose fibres
22 first fibres
22a second fibres
23 milled fibres
24 dried fibres
25 polymer
26 predetermined mixture
27 granules
28 fuel pellets

1. Method to process cellulose fibres (21), preferably including wood fibres, comprising the steps:
Deriving first fibres (22) having a first property from a first raw material comprising cellulose fibres (21),
S2 Milling the first fibres (22) to provide milled fibres (23), preferably with an average characteristic fibre dimension greater than 100 μm,
S3 Drying the milled fibres (23) to provide dried fibres (24) having a residual moisture less than 10% by weight,
S4 Adding one or more polymers (25), preferably including Lignin, to the dried fibres (24) to provide a predetermined mixture (26) including a polymer weight fraction of at least 5%,
S5 Processing the predetermined mixture (26) to provide granules (27) with an average characteristic granule dimension between 2 to 6 mm.

2. Method according to claim 1, wherein the cellulose fibres (21) originate from a single species of plants.

3. Method according to claim 1, wherein step S1 includes: Passing some of the first fibres (22) through a first dimension sensitive device (9) and/or retaining some of the first fibres (22) by a second dimension sensitive device (9a).

4. Method according to claim 1, wherein step S1 includes Selecting first fibres based on their colour and/or their geometry.

5. Method according to claim 1, wherein step S2 is performed with a grinding device (11) and preferably with a third dimension sensitive device (9b).

6. Method according to claim 1, wherein step S3 is performed with a vacuum dryer or dispersion dryer.

7. Method according to claim 1, wherein for step S4 at least one of the polymers is selected from the following group including a thermoplast, lignin, polyethylene, polypropylene, polystyrene, polyamide, polycarbonate, acrylonitrile butadiene styrene, polymethyl methacrylate and polyoxymethylene.

8. Method according to claim 1, wherein step S4 includes: Adding second fibres (22a) from a second raw material to the predetermined mixture (26).

9. Method according to claim 1, wherein step S5 is performed with an extruder or a multi screw extruder.

10. Method according to claim 1, further comprising:
S6 Supplying the granules (27) to a storage tank (8), from which some of the granules (27) may be transferred to a mobile tank.

11. Method according to claim 1, wherein step S1 also includes deriving second fibres (22a) having a second property from the first raw material, the method further comprising:
S7 Forming fuel pellets (28) from the second fibres (22a).

12. Method according to claim 1, wherein step S1 also includes deriving second fibres (22a) having a second property from the first raw material, the method further comprising the steps:
S8 Processing the second fibres to gain thermal energy Q [J],
S9 Providing the thermal energy Q during step S3 or step S4 or step S5.

13. Apparatus (1) for processing cellulose fibres (21), preferably including wood fibres, comprising:
deriving means (2) arranged for deriving first fibres (22) having a first property from a first raw material comprising cellulose fibres (21),
milling means (3) arranged for receiving the first fibres (22) from the deriving means (2), for milling the first fibres (22), for providing milled fibres (23) with an average characteristic fibre dimension greater than 100 μm,
drying means (4) arranged for receiving the milled fibres (23) from the milling means (3), for drying the milled fibres (23), for providing dried fibres (24) having a residual moisture less than 10% by weight,
adding means (5) arranged for receiving the dried fibres (24) from the drying means (4), for adding one or more polymers (25), preferably including Lignin, to the dried fibres (24), for providing a predetermined mixture (26) including a polymer weight fraction of at least 5%,
processing means (6) arranged for receiving the predetermined mixture (26) from the adding means (5), for processing the predetermined mixture (26), for providing granules (27) with an average characteristic granule dimension between 2 to 6 mm.

14. Apparatus according to claim 13, wherein the deriving means (2) comprises a first dimension sensitive device (9) arranged for being passed by some of the first fibres (22) and/or a second dimension sensitive device (9a) arranged for retaining some of the first fibres (22).

15. Apparatus according to claim 13, wherein the deriving means (2) comprise an optical device arranged for determining the colour and/or the geometry of some of the first fibres (22).

16. Apparatus according to claim 13, wherein the milling means (3) comprise grinding device (11) and a third dimension sensitive device (9b).

17. Apparatus according to claim 13, wherein the drying means (4) comprise a vacuum dryer or a dispersion dryer.

18. Apparatus according to claim 13, wherein the adding means comprise a mixing device for setting a fraction of the dried fibres from a first raw material (first dried fibres) and a fraction of dried fibres from a second raw material (second dried fibres).

19. Apparatus according to claim 13, comprising an extruder or a multi screw extruder arranged for processing the predetermined mixture (26) and for providing granules (27) with an average characteristic granule dimension between 2 to 6 mm.

20. Apparatus according to claim 13, further comprising a storage tank (8) arranged for receiving some of the granules (27) and arranged for releasing some of the granules (27) to a mobile tank.

21. Apparatus according to claim 13, further comprising pelletising device (10) arranged for forming fuel pellets (28) from second fibres (22a) having a second property, wherein the second fibres (22a) are derivable from the first raw material by the deriving means (2).

22. Apparatus according to claim 13, wherein the deriving means (2) are further arranged for deriving second fibres (22a) having a second property from the first raw material comprising cellulose fibres (21), further comprising a heat exchanger (7) arranged for transferring thermal energy Q gained from the second fibres (22a) to at least one of the drying means (4), the adding means (5) and the processing means (6).

23. Product produced by a method according to claim 1.
